(19) United States
(12) Patent Application Publication
(10) Pub. No.: US 2009/0150807 A1
(43) Pub. Date: Jun. 11, 2009

(54) METHOD AND APPARATUS FOR AN IN-CONTEXT AUTO-ARRANGABLE USER INTERFACE

(75) Inventors: David A. George, Somers, NY (US); Raymond R. Hitney, Buchanan, NY (US); Raymond B. Jennings, III, Ossining, NY (US); Malgorzata E. Stys, Purdys, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/952,031

(22) Filed: Dec. 6, 2007

(51) Int. Cl. G06F 3/048

(52) U.S. Cl. 715/763

(57) ABSTRACT

A method for dynamically re-calculating and presenting a graphical user interface (GUI) that includes interface icons based on user context, includes, for a current user, determining a change in user context associated with the GUI. The method then modifies one of a state, appearance and spatial placement of the user interface icons within the GUI automatically, in accordance with a determined change in user context. The step of determining a change in user context may further include analyzing a set of contextual attributes associated with the user. For that matter, the step of determining is preferably automatically triggered by at least one factor from a group of factors, the group of factors including a) a creation date of a data item associated with the current user, b) a modification date of a data item associated with the current user, c) a last-accessed date of a data item associated with the current user, d) a type of a data item associated with the current user, e) a location of a data item associated with the current user, f) a category of a data item's content, the data item associated with the current user, g) a size of a data item, the data item associated with the current user, h) a source of a data item associated with the current user and i) a completeness of a data item associated with the current user.

### BACKGROUND OF THE INVENTION

The present invention relates to Windows-based graphical user interfaces, and more particularly relates to an in-context, auto-arrangeable graphical user interface, wherein user interface icons automatically change their appearance in view of the users circumstances, including but not limited to task deadlines, to-do tasks, incoming event notifications, and in-context association with the user's current activities.

Window-based graphical user interfaces (GUIs), such as those available with Microsoft Windows (including CE), numerous UNIX GUI implementations and those GUIs known to be used by/with Apple Computers, typically provide user-arrangeable screens and program launching means. A major challenge of using such known user-arrangeable GUIs is that they leave users with the challenge of arranging favorite icons that represent tasks, programs or content that they may require, which are launched by a mouse click.

For example, prior art FIG. 1 herein shows a conventional graphical user interface (GUI) within a viewable screen 101 including a set of traditional interface icons 103. Interface icons 103 are placed and seen within the boundaries of display 101. Such screens are included in numerous computer systems such as personal computers (PC), including laptops and hand-held devices.

Known user-arrangeable GUIs lack the ability to dynamically and automatically adjust the GUI display to include GUI icons based of the current user's personal circumstances. That is, there is no known means for automatically adjusting the conventional user-arrangeable GUIs to highlight, and render readily accessible GUI icons associated with application programs that might be needed by the user, and are reflected in information available and relating to the user's deadlines, to-do lists, (user) incoming event notifications, in-context association of the user's current computing activities, etc., or are otherwise indicative of such personal tasks and task events.

While some innovations to conventional user-arrangeable interfaces have emerged, or are known to provide improvements in various aspects of user-arrangeable graphical user interfaces (for example, by making the GUI more aesthetically more appealing), the known improvements may be characterized as “substantially superficial” because they do not provide additional true functionality. For example, prior art windowing techniques and GUI improvements might include using a status bar are known to show icons that may alter in appearance, such as the flag on a mailbox signifying new mail. Other known windowing techniques include cartoon cloud messages and pop-up dialogs, but as mentioned, do not provide substantive improvements in overall function.

Hence, there is a distinct need in the art of graphical user interfaces, and their operation, and for methods and computer systems that operate with GUIs, for an in-context, auto-arrangeable graphical user interface that overcomes the shortcomings of the prior art.

### SUMMARY OF THE INVENTION

To that end, the present invention comprises a novel windows-based, in-context, auto-arrangeable graphical user interface (GUI), method of using such a novel windows-based, in-context, auto-arrangeable graphical user interface (GUI), and computer system constructed to include the novel windows-based, in-context, auto-arrangeable graphical user interface (GUI), which include user interface icons within one or more GUI displays that are automatically modified in their appearance (within the graphical user interface). Such novel icon appearance changes are implemented either with respect to placement in the graphical user interface, or in view of determined appearance and/or characteristics of the icons themselves.

The invention allows the user to define a core set of desktop icons, which are auto-arranged according to a current user's context. These include: fading or hiding icons of infrequent or non-contextual use, brightening icons and arranging them for prime visibility on the basis of frequency of use, current activity or pending “to-dos,” changing the appearance of icons, for example, placing a flame under an icon, to render it more urgent to the user, creating temporary shortcut icons for impending tasks, including some shortcuts to allow invoking the dialog of a presently running program, and moving icons representing already launched programs off the primary viewing range, unless duplicates of the program are anticipated.

The icons' appearances and characteristics are automatically modified by a triggering process that with an ability to automatically detect events external the GUI, but related to user context. For example, an icon appearance may be automatically modified as a result of running application programs, or by the completion of tasks associated with a running application program, attributes and/or state changes in a computing system within which the novel method is operating (running), as well as by input provided by the user via the novel GUI.

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 depicts a graphical user interface (GUI) display, and interface icons as known in the conventional arts;

FIG. 2 depicts one embodiment of a graphical user interface (GUI) display of the invention, in which an icon present therein has been automatically moved (i.e., had a location-change) into a main GUI viewing area to better stand out and draw the attention of the user;

FIG. 3 depicts another embodiment of the GUI display of the invention, highlighting an icon that has been automatically changed in appearance by enlargement to better stand out and draw the attention of the user;

FIG. 4 depicts another embodiment of the GUI display of the invention, highlighting a plurality of icons superimposed or automatically stacked upon top in a fixed screen or GUI space to conserve space within the GUI display; and

FIG. 5 herein is a schematic diagram depicting a computer-based system 500 by which the method which implements the novel GUI display operation of the present invention may be carried out.

### DETAILED DESCRIPTION OF THE INVENTION

The inventive windows-based, in-context, auto-arrangeable graphical user interface (GUI), method of using such novel GUI and computer system constructed to include the novel GUI, are set forth and described herein for the purpose of conveying the invention's broad concepts. In particular, the drawings and descriptions provided are not intended to be exclusive, and/or intended to limit the scope and spirit of the invention, which is intended to be limited only by the language of the claims appended hereto. To that end, reference will now be made in detail to the present invention, examples of which are illustrated in the accompanying drawings, wherein like reference numerals refer to like elements throughout.

A first embodiment of the invention includes a novel method for dynamically re-calculating and presenting a graphical user interface (GUI) in which the GUI's state, its appearance and/or the placement of its interface icons are automatically modified in response to automatic triggering by contextual attributes, or by a change in state of a contextual attribute. Contextual attributes include one or more of: a creation date of a data item, a modification date of a data item, last accessed date of a data item, a type of a data item, a location of a data item, a degree of completeness of a data item, an actual content within a data item, a size of a data item and a source of a data item. A data item comprises, without limitation, a file, a service procedure or a reference. The contextual attributes are adjusted automatically by triggers that are learned from a user's habits, a user's prior actions or by a user's specified policies.

In more detail, a method for dynamically re-calculating and presenting a graphical user interface (GUI) comprised of interface icons based on user context, includes, for a current user, determining a change in user context associated with the GUI. The method then includes modifying one of a state, appearance and spatial placement of user interface icons within the GUI automatically in accordance with a determined change in user context. The step of determining a change in user context may further include analyzing a set of contextual attributes associated with the user. For that matter, the step of determining is preferably automatically triggered by at least one factor from a group of factors, the group of factors consisting of: a) a creation date of a data item associated with the current user, b) a modification date of a data item associated with the current user, c) a last-accessed date of a data item associated with the current user, d) a type of a data item associated with the current user, e) a location of a data item associated with the current user, f) a category of a data item's content, the data item associated with the current user, g) a size of a data item, the data item associated with the current user, h) a source of a data item associated with the current user and i) a completeness of a data item associated with the current user.

The novel method may further include that the automatic triggering by the at least one factor of the group of factors is controlled by user-specifiable policy declarations associated with one or more of the factors. For that matter, the automatic triggering by the at least one factor of the group of factors may derive from a user's GUI environmental history, which is automatically derived and compiled in association with the user's prior use history and habitual uses, or from collaborative sources consisting of at least one of: a) other users, b) internal references of changing external items, c) changing external references to the item, and d) modification of programs that are dependent on the data item. The data item may comprise a reference to any of a group consisting of: a) computer programs, b) computer files, c) computer services, computer procedures or functions that are called during operation of a computer program and d) secondary references.

The automatic triggering by the at least one factor of group of factors automatically causes a creation of a user interface icon, and that the created user interface icon is presented in the GUI as a classic icon representative of a reference, and launchable as a shortcut to the reference, and determines an appearance of the created user interface icon in the context of the present user interface, the appearance rendering the created icon prominent in the user's GUI view. The method may further include a step of altering an appearance of the user interface icon by altering visible factors, including but not limited to the user interface icon's brightness, size, decoration, and a time gradient of the icon's brightness, size and decoration in order to render an eye-catching appearance, to automatically renders the eye-catching appearance in appropriate spatial position in the user's field of view.

The step of altering automatically places the icons with the eye-catching appearance in a limited spatial area in which may be present and a plurality of interface icons, at least two of which can share the same visual spatial position within the GUI by fading (morphing) from one such interface icon to another over a time, thereby allowing the user to select the active interface icon, wherein the morphing is momentarily frozen during the selecting. A step of discarding or removing an automatically created user interface icon upon an occurrence of factors warranting its removal may be included, and preferably further includes removing the user interface icon in response to one of: a removal of a related file, user deletion, because criteria determining its display are no longer met, a user context includes learning the user's policy for removing a user interface icon and a user context includes learning user preferences in icon placement and appearance as a result of capturing the user's adjustments to the icon.

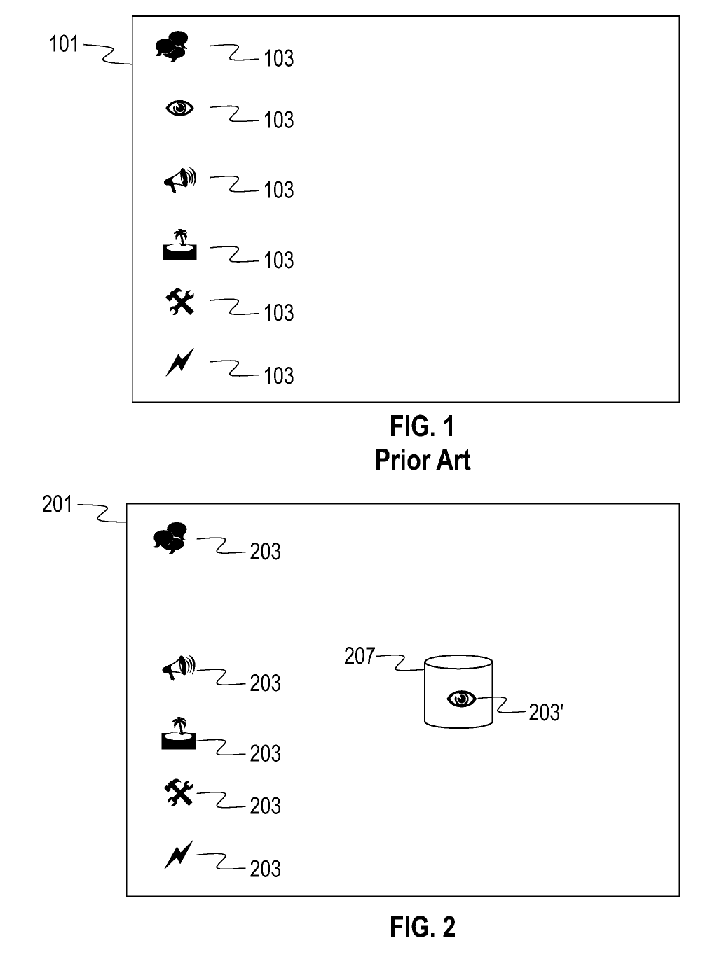

FIG. 2 herein shows a GUI generated by the first method embodiment as comprising a viewable screen or display 201 within which a particular icon, interface icon 203′, has been automatically moved or arranged just above (or superimposed upon) a current, active application's window 207. As should be readily apparent, the inventive method has automatically moved icon 203′ from its position within the GUI as it was shown in prior art GUI 101 in FIG. 1, into a main GUI viewing area or application window 207 in order that it better stand out and draw the attention of the user.

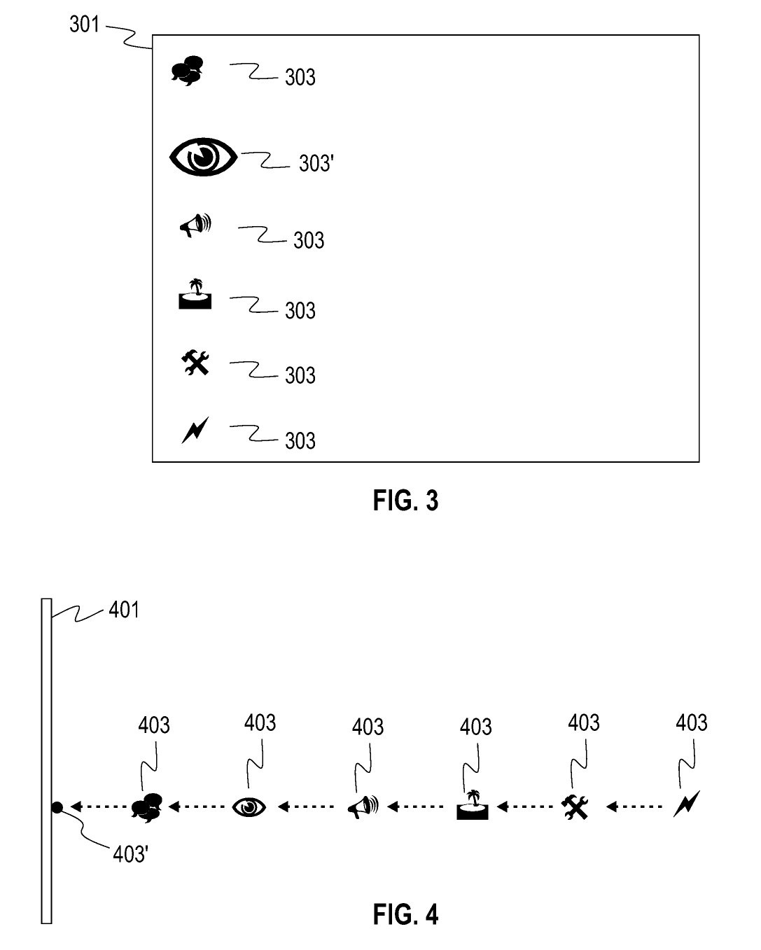

FIG. 3 herein shows yet another embodiment of a GUI of the invention, comprising a viewable screen or display 301, wherein one particular icon 303′, of a set of icons 303 (as shown), has undergone an automatic change of appearance based on some pre-determined user context. In this particular example as shown, the change in appearance includes that the interface icon 303′ has become enlarged in size such that it readily and noticeably stands out among the other icons 303 in the icon set shown.

Alternatively, interface icon 303′ as shown in the FIG. 3 embodiment could be increased in brightness, in contrast, in color, by some added decoration or some plurality of the aforementioned changes in order to readily distinguish it from the other icons (303) as seen in the figure. Such interface icon appearance changes may comprise a single static change in the icon's appearance, or may comprise a periodic change such as by automatically morphing into a blinking icon, or as an icon such as interface icon 103′ with animated features.

FIG. 4 herein depicts a three-dimensional view of a screen or GUI display 401 of the invention, as depicted in a side view, in order to highlight the three-dimensional aspect of the instant GUI, and its improved viewability. That is, display or screen 401 as shown is arranged to accommodate particular conditions in which interface icons 403 may be required to be displayed in a limited display space, or screen area. To accommodate these conditions, and as seen in the three-dimensional side view of display 401, a set of interface icons 403 are stacked on top of each other (virtually stacked) in an icon space identified by element 403′ in the figure. In the embodiment, each interface icon 403 is provided on the display's GUI for a given or fixed time period. When each interface icon 403 has finished its display period in fixed location 403′, it is moved to the “back” of the set (farthest from the screen or display surface), so that the “next” interface icon, which was “underneath” the moved icon, may be displayed (at the tope of the stack). The association by which icons will be automatically stacked, and the top icon displayed within the display area 403′ is determined by the set of user contextual attributes described previously.

Included within each of the GUI embodiments shown in FIGS. 1-4 is an ability to enable a user to discard or remove any icon from a graphical user interface. Removal methods include manual removal by the user, or automatic removal of an interface icon at the occurrence of a predetermined condition. For example, automatic removal may comprise removing an interface icon upon or coincidentally with removal of an application program the icon represents, or other case where the icon's underlying content is removed, e.g., a file being deleted. In another example, the interface icon may be automatically removed because the underlying content no longer meets the criteria for the interface icon to be displayed. For example, in a case where a spreadsheet file no longer contains any errors within it, and where an error is one reported by the underlying spreadsheet application. Alternatively, an icon will be automatically removed based on a user's previous history, for example, the automatic removal of icons when the computer is shutdown.

For that matter, other “triggers,” or predetermined conditions for automatically modifying the GUI of this invention may be arranged according to a user's preference, or manufacturer's preference, for the purpose of displaying, altering or removing an interface icon from the graphical user interface, without deviating from the scope or spirit of the invention.

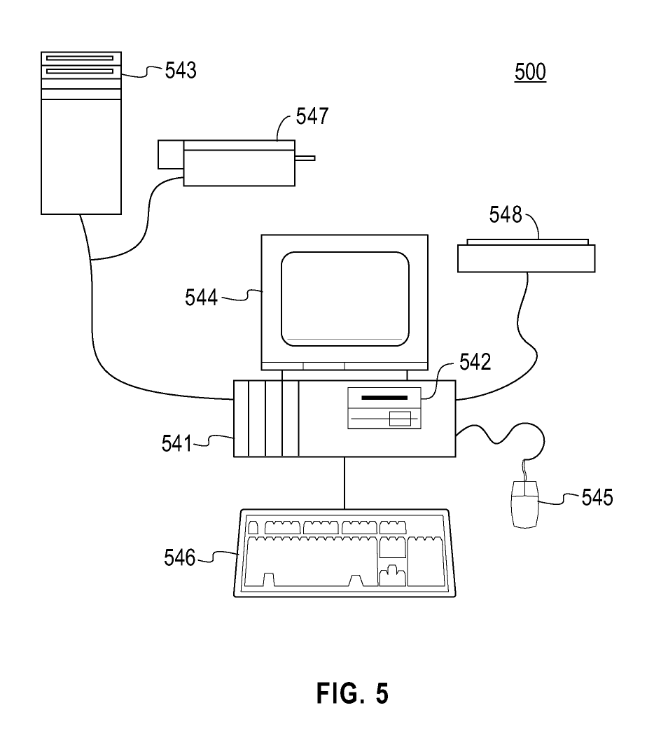

The various method embodiments of the invention will be generally implemented by a computer executing a sequence of program instructions for carrying out the steps of the methods, assuming all required data for processing is accessible to the computer. The sequence of program instructions may be embodied in a computer program product comprising media storing the program instructions. A computer-based system 500 is depicted in FIG. 5 herein by which the method of the present invention may be carried out. Computer system 500 includes a processing unit 541, which houses a processor, memory and other systems components that implement a general purpose processing system or computer that may execute a computer program product comprising media, for example a compact storage medium such as a compact disc, which may be read by processing unit 541 through disc drive 542, or any means known to the skilled artisan for providing the computer program product to the general purpose processing system for execution thereby.

The program product may also be stored on hard disk drives within processing unit 541 or may be located on a remote system, such as a server 543, coupled to processing unit 541, via a network interface, such as an Ethernet interface. Monitor 544, mouse 545 and keyboard 546 are coupled to processing unit 541, to provide user interaction. Scanner 547 and printer 548 are provided for document input and output. Printer 548 is shown coupled to processing unit 541 via a network connection, but may be coupled directly to the processing unit. Scanner 547 is shown coupled to processing unit 541 directly, but it should be understood that peripherals may be network coupled or direct coupled without affecting the ability of workstation computer 540 to perform the method of the invention.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The method in one embodiment includes a step of determining a change in current user context includes analyzing a set of contextual attributes associated with the user. For that matter, the step of determining a change in current user context is automatically triggered by at least one factor from a group of factors, the group of factors consisting of: a) a creation date of a data item associated with the current user, b) a modification date of a data item associated with the current user, c) a last-accessed date of a data item associated with the current user, d) a type of a data item associated with the current user, e) a location of a data item associated with the current user, f) a category of a data item's content, the data item associated with the current user, g) a size of a data item, the data item associated with the current user, h) a source of a data item associated with the current user and I) a completeness of a data item associated with the current user.

The automatic triggering in the step of determining the change in current user context by the at least one factor of the group of factors is controlled by user-specifiable policy declarations, which declarations are associated with one or more of the factors. The automatic triggering in the step of determining the change in current user context by the at least one factor of the group of factors derives from a user's GUI environmental history, which user's GUI environmental history is automatically derived and compiled in association with the user's prior use history and habitual uses. Alternatively, the automatic triggering in the step of determining the change in current user context by the at least one factor of the group of factors derives from collaborative sources, the collaborative sources consisting of at least one of: a) other users, b) internal references of changing external items, c) changing external references to the item, and d) modification of programs that are dependent on the data item.

The method may include that the data item comprises a reference to any of a group consisting of: a) computer programs, b) computer files, c) computer services, computer procedures or functions that are called during operation of a computer program and d) secondary references, or that the automatic triggering and determining the change in current user context by the at least one factor of group of factors automatically causes a creation of a user interface icon, and that the created user interface icon is presented in the GUI as a classic icon representative of a reference, and launchable as a shortcut to the reference. A step of determining an appearance of the created user interface icon in the context of the present user interface, where the appearance renders the created icon prominent in the user's GUI view. Method may also include a step of altering an appearance of the user interface icon by altering visible factors, including but not limited to the user interface icon's brightness, size, decoration, and a time gradient of the icon's brightness, size and decoration in order to render an eye-catching appearance. The step of altering the appearance of the user interface icon automatically renders the eye-catching appearance in appropriate spatial position in the user's field of view.

The method may include that the step of altering automatically places the icons with the eye-catching appearance in a limited spatial area in which may be present and a plurality of interface icons, at least two of which can share the same visual spatial position within the GUI by fading (morphing) from one such interface icon to another over a time, thereby allowing the user to select the active interface icon, wherein the morphing is momentarily frozen during the selecting. The novel method may further include a step of discarding or removing an automatically created user interface icon upon an occurrence of factors warranting its removal, wherein the step of discarding or removing includes removing the user interface icon in response to one of: a removal of a related file, user deletion, because criteria determining its display are no longer met, a user context includes learning the user's policy for removing a user interface icon and a user context includes learning user preferences in icon placement and appearance as a result of capturing the user's adjustments to the icon.

Although a few examples of the present invention have been shown and described, it would be appreciated by those skilled in the art that changes may be made in these embodiments without departing from the principles and spirit of the invention, the scope of which is defined in the claims and their equivalents.

1. A method implemented in a computer device for dynamically re-calculating and presenting a graphical user interface (GUI) comprised of interface icons, an interface icon representing a data item, the recalculating and presenting based on user context, the method comprising the steps of:
for a current user, automatically determining a change in user context associated with the GUI, said determining a change in current user context being automatically triggered by at least one factor from a group of factors comprising: a) a type of a data item associated with the current user, b) a location of a data item associated with the current user, c) a size of a data item, the data item associated with the current user, d) a source of a data item associated with the current user and, e) a completeness of a data item associated with the current user, said at least one trigger factor provided as one or more of: 1) a user-specifiable policy declaration associated with one or more of said factors: 2) a learned association of the data item for the current user with tat user's habitual activity, or 3) the current user with a current activity; and
modifying one of a state, appearance and spatial placement of user interface icons within the GUI to be re-calculated and presented, automatically in accordance with the determined change in user context associated with the GUI, said modifying including: determining an appearance of a user interface icon in the context of the present GUI, and, altering an appearance of the user interface icon by altering visible factors, including one or more of: the user interface icon's visibility, brightness, size, decoration, and a time gradient of said icon's brightness, size and decoration in order to render said appearance of interface icon more prominent in the user's GUI view.

2. A computer program product, the computer program product comprising:
a tangible storage medium readable by a processing circuit and storing instructions for execution by the processing circuit for performing a method set forth in claim 1.
